(19) United States
(12) Patent Application Publication
(10) Pub. No.: US 2025/0238685 A1
(43) Pub. Date: Jul. 24, 2025

(54) DATA PROCESSING DEVICE, COMPUTER-READABLE RECORDING MEDIUM STORING PROGRAM, AND DATA PROCESSING METHOD

(71) Applicant: Fujitsu Limited, Kawasaki-shi (JP)

(72) Inventors: Fang YIN, Kawasaki (JP); Yasuhiro WATANABE, Kawasaki (JP); Hirotaka TAMURA, Yokohama (JP)

(73) Assignee: Fujitsu Limited, Kawasaki-shi (JP)

(21) Appl. No.: 19/019,966

(22) Filed: Jan. 14, 2025

(30) Foreign Application Priority Data
Jan. 24, 2024 (JP) 2024-008804

(51) Int. Cl. G06N 5/01

(52) U.S. Cl. CPC G06N 5/01

(57) ABSTRACT

A data processing device includes a memory configured to store evaluation function information of an evaluation function of a combinatorial optimization problem represented by a sum of a quadratic cost term and a linear cost term that is a sum of constraint terms weighted by a coefficient that represents a weight of each of constraint conditions, and a processor configured to search for a solution to the combinatorial optimization problem based on the evaluation function information, increase a value of the coefficient in a case of constraint violation at a first time point during the search, and determine whether to decrease or maintain the value of the coefficient based on a value of the quadratic cost term at the first time point and a value of the evaluation function obtained before the first time point in a case where the constraint conditions are satisfied at the first time point.

### CROSS-REFERENCE TO RELATED APPLICATION

This application is based upon and claims the benefit of priority of the prior Japanese Patent Application No. 2024-8804, filed on Jan. 24, 2024, the entire contents of which are incorporated herein by reference.

### FIELD

The embodiments discussed herein are related to a data processing device, a program, and a data processing method.

### BACKGROUND

There is a method of converting a combinatorial optimization problem into an Ising model that represents a spin behavior of a magnetic body at a time of searching for a solution to the combinatorial optimization problem. The Ising model is represented by an Ising-type evaluation function that evaluates the solution to the combinatorial optimization problem. The Ising-type evaluation function includes a plurality of state variables (representing a state of the Ising model) and a plurality of weight values. In the Ising-type evaluation function, the state variable is a binary variable that takes a value of 0 or 1 (or −1 or +1). The state variable may be referred to as a bit. Furthermore, a value of the Ising-type evaluation function may also be referred to as energy of the Ising model.

In the solution search, a Markov-Chain Monte Carlo (MCMC) method is used. Hereinafter, the solution search based on the MCMC method will be referred to as an MCMC search. In the MCMC search, for example, a state transition is accepted with an acceptance probability of the state transition specified by a Metropolis method or a Gibbs method. At this time, a state transition that increases energy is also stochastically permitted. Note that the acceptance probability decreases as an amount of increase in the energy increases. Examples of the MCMC method include simulated annealing and a replica exchange method. In such an MCMC search, a state of the Ising model where the value of the Ising-type evaluation function is minimized is searched for. The state where the minimum value of local minimum values of the evaluation function is reached is to be an optimal solution.

Meanwhile, some combinatorial optimization problems have constraint conditions to be satisfied by a solution, and a method of performing a search in consideration of the constraint condition has been proposed. Examples of the constraint condition include an inequality constraint, an equality constraint, an absolute value constraint, and the like. The evaluation function reflecting the constraint condition includes a constraint term having a value corresponding to presence or absence of constraint condition violation. The constraint term is weighted by a coefficient representing weight of the constraint condition.

Japanese Laid-open Patent Publication No. 2021-089596, Japanese Laid-open Patent Publication No. 2022-047362, U.S. Patent Application Publication No. 2016/0217380, and Japanese Laid-open Patent Publication No. 2023-149726 are disclosed as related arts.

### SUMMARY

According to an aspect of the embodiments, a data processing device includes a memory configured to store evaluation function information of an evaluation function of a combinatorial optimization problem represented by a sum of a quadratic cost term and a linear cost term that is a sum of a plurality of constraint terms weighted by a coefficient that represents a weight of each of a plurality of constraint conditions, and a processor configured to acquire the evaluation function information from the memory, search for a solution to the combinatorial optimization problem based on the evaluation function information, increase a value of the coefficient that corresponds to a first constraint condition in a case where there is the first constraint condition in which constraint violation occurs among the plurality of constraint conditions at a first time point during the search for the solution, and determine whether to decrease or maintain the value of the coefficient that corresponds to the plurality of constraint conditions based on a result of comparison between a value of the quadratic cost term at the first time point and a value of the evaluation function obtained before the first time point in a case where the plurality of constraint conditions is satisfied at the first time point.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a data processing device and a data processing method of a first embodiment;

FIG. 2 is a block diagram illustrating a hardware example of a data processing device of a second embodiment;

FIG. 3 is a block diagram illustrating a functional example of the data processing device;

FIG. 4 is a diagram illustrating an example of a variable setting unit and a λₖ adjustment unit;

FIG. 5 is a flowchart illustrating a flow of an example of the data processing method;

FIG. 6 is a flowchart illustrating a flow of an example of a processing procedure of a Markov-Chain Monte Carlo (MCMC) search; and

FIG. 7 is a diagram illustrating another example of the data processing device.

### DESCRIPTION OF EMBODIMENTS

In a case where a value of the coefficient representing the weight of the constraint condition is not appropriate, search efficiency may deteriorate in the MCMC search. For example, when the value of the coefficient representing the weight of the constraint condition is small, the amount of increase in the energy at a time of transitioning to a state not satisfying the constraint condition (hereinafter referred to as a constraint violation solution) decreases. In this case, the constraint violation solution is likely to occur, and the search efficiency deteriorates. On the other hand, when the value of the coefficient described above is large, the state transition is less likely to occur, and the search efficiency deteriorates.

In one aspect, an object of an embodiment is to provide a data processing device, a program, and a data processing method capable of improving efficiency in searching for a solution to a combinatorial optimization problem.

Hereinafter, modes for carrying out an embodiment will be described with reference to the drawings.

### First Embodiment

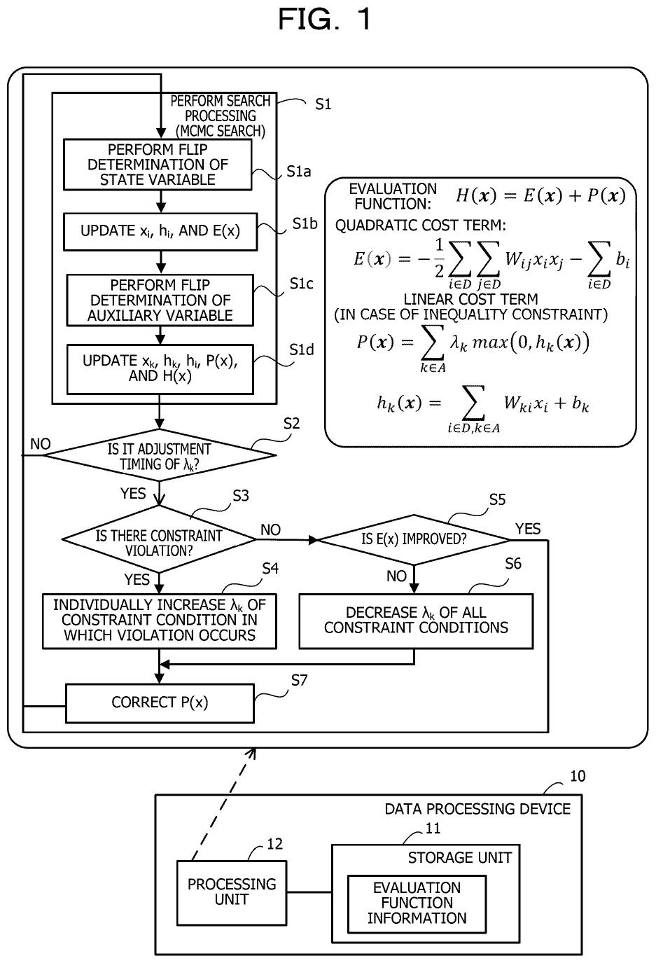

FIG. 1 is a diagram illustrating an example of a data processing device and a data processing method of a first embodiment.

A data processing device 10 of the first embodiment includes a storage unit 11 and a processing unit 12.

The storage unit 11 is a volatile storage device (for example, electronic circuit such as dynamic random access memory (DRAM)), or a non-volatile storage device (for example, electronic circuit such as a flash memory, hard disk drive (HDD), or the like). The storage unit 11 may include an electronic circuit such as a register.

The storage unit 11 stores evaluation function information of an evaluation function of a combinatorial optimization problem including a plurality of constraint conditions.

The evaluation function (H(x)) of the combinatorial optimization problem including the plurality of constraint conditions is represented by the following Expression (1).

$$H ( x ) = E ( x ) + P ( x ) \qquad ( 1 )$$

H(x) may also be referred to as total energy.

In Expression (1), E(x) is a quadratic cost term, and may be represented by, for example, the following Expression (2).

$$\begin{matrix}[ Expression 2 ] & \\ E ( x ) = - \frac{1}{2} {\sum }_{i ∈ D} {\sum }_{j ∈ D} {W}_{ij} {x}_{i} {x}_{j} - {\sum }_{i ∈ 1} {b}_{i} {x}_{i} & ( 2 )\end{matrix}$$

A first term on a right side is for integrating products of values (0 or 1) of two state variables and a weight value (representing strength of correlation between the two state variables) for all combinations of all state variables (xᵢ) with neither omission nor duplication. A state variable with an identification number i is represented by xᵢ, a state variable with an identification number j is represented by xⱼ, and a weight value indicating magnitude of correlation between the state variables having i and j as the identification numbers is represented by Wᵢⱼ. A second term on the right side is for obtaining a total sum of products of a bias coefficient and a state variable for each identification number. A bias coefficient for the identification number=i is represented by bᵢ.

Note that a set of the identification numbers of the state variables is represented by D. The state variable may also be referred to as a decision variable. Expression (2) may also be referred to as the Ising-type evaluation function described above.

In Expression (1), P(x) is a linear cost term represented by a sum of a plurality of constraint terms, and may be represented by the following Expression (3).

$$\begin{matrix}[ Expression 3 ] & \\ P ( x ) = {\sum }_{k ∈ A} {λ}_{k} g ( {h}_{k} ) & ( 3 )\end{matrix}$$

An identification number of a constraint condition (or constraint term) is represented by k. Furthermore, λₖ is a predetermined positive coefficient representing a weight of the constraint condition with the identification number k. Each constraint term is weighted by λₖ. Note that A represents a set of the identification numbers of the constraint conditions.

A penalty function, which differs depending on a type of the constraint condition, is represented by g(hₖ). It may be said that λₖg(hₖ) is one constraint term. A value used to specify a constraint violation amount for the constraint condition with the identification number k is represented by hₖ.

In a case where the constraint condition is an inequality constraint, g(hₖ) may be represented by the following Expression (4).

$$\begin{matrix}[ Expression 4 ] & \\ g ( {h}_{k} ) = max [ 0 , {h}_{k} ] & ( 4 )\end{matrix}$$

$${h}_{k} = {\sum }_{i ∈ D , k ∈ A} {W}_{ki} {x}_{i} + {b}_{k}$$

In Expression (4), max[0, hₖ] is a function that outputs the larger value of 0 and hₖ. Furthermore, Wₖᵢ is a coefficient (weight value) representing a weight of xᵢ in the inequality constraint with the identification number k. A bias coefficient for the inequality constraint with the identification number k is represented by bₖ.

As in Expressions (1) to (3), H(x) is represented by a sum of the quadratic cost term (E(x)) and the linear cost term (P(x)) that is a sum of the plurality of constraint terms weighted by the coefficient (λₖ) representing the weight of each of the plurality of constraint conditions.

The evaluation function information stored in the storage unit 11 includes, for example, Wᵢⱼ and bᵢ in Expression (2), a value of λₖ in Expression (3), and Wₖᵢ and bₖ in Expression (4). Note that the storage unit 11 may store a value of the state variable (xᵢ), a value of H(x), a value of E(x), and a value of P(x). Furthermore, the storage unit 11 may store values of M auxiliary variables (xₖ) representing presence or absence of violation of each of the plurality (hereinafter referred to as M) of constraint conditions. In the following description, description will be made assuming that xₖ has a value of 1 in the case of violating the constraint condition with the identification number=k and has a value of 0 in the case of satisfying the constraint condition, but the present disclosure is not limited to this. A spin variable having a value of −1 or +1 may also be used as xₖ.

Moreover, the storage unit 11 may store hᵢ representing a change amount of E(x) in a case where each value of the plurality of xᵢ changes. Note that, hereinafter, hᵢ may be referred to as a first local field, and the above-described hₖ may be referred to as a second local field. When initial values of hᵢ and hₖ are stored, bᵢ of Expression (2) and bₖ of Expression (3) do not have to be stored. Furthermore, the storage unit 11 may store an increase amount Δλₖ₊ and a decrease amount Δλₖ₋ when λₖ is adjusted. Each of Δλₖ₊ and Δλₖ₋ may be set to a different value for each constraint condition.

Furthermore, the storage unit 11 may store various types of data such as calculation conditions when the processing unit 12 executes the data processing method to be described later. Furthermore, in a case where the processing unit 12 executes a part or all of processing of the data processing method to be described later by software, the storage unit 11 stores a program for executing the processing.

The processing unit 12 in FIG. 1 may be implemented by, for example, a processor that is hardware such as a central processing unit (CPU), a graphics processing unit (GPU), or a digital signal processor (DSP). Furthermore, the processing unit 12 may be implemented by using an electronic circuit such as an application specific integrated circuit (ASIC) or a field programmable gate array (FPGA).

The processing unit 12 acquires the evaluation function information from the storage unit 11, and searches for a solution to the combinatorial optimization problem based on the evaluation function information. For example, a state where H(x) indicated in Expression (1) is minimum (a combination of values of state variables) is searched for as the solution. A state where a minimum value of local minimum values of H(x) is reached is to be an optimal solution. Note that the processing unit 12 may also search for a state where the value of H(x) is maximized (in this case, a state where a maximum value is reached is to be the optimal solution) by changing signs of the respective terms on the right side of the Expression (1).

In FIG. 1, a flow of an example of processing by the processing unit 12 is illustrated. Note that, hereinafter, an example using the auxiliary variable (xₖ) will be indicated, but hₖ may also be used instead of xₖ. Furthermore, here, it is assumed that values based on initial values of N pieces of xᵢ (xᵢ=x₁ to x_{N}) are stored in the storage unit 11 as initial values of E(x), P(x), hᵢ, hₖ, and xₖ.

The processing unit 12 performs the following processing of steps S1 to S4 at a time of solution search based on a Markov-Chain Monte Carlo (MCMC) method. First, the processing unit 12 performs solution search processing based on the MCMC method (MCMC search) (step S1). The search processing includes, for example, processing of flip determination of the state variable (step S1a), update of xᵢ, hᵢ, and E(x) (step S1b), flip determination of the auxiliary variable (step S1c), and update of xₖ, hₖ, hᵢ, P(x), and H(x) (step S1d).

The processing of step S1a is performed as follows, for example.

The processing unit 12 determines whether or not to permit a change in a value of one (hereinafter referred to as a flip candidate state variable) of the N pieces of xᵢ based on hᵢ. The processing unit 12 selects the flip candidate state variable at random or in a predetermined order, for example. The following Expression (5) may represent hᵢ.

$$\begin{matrix}[ Expression 5 ] & \\ {h}_{i} = {\sum }_{j ∈} {W}_{ij} {x}_{j} + {b}_{i} & ( 5 )\end{matrix}$$

Note that, in the present embodiment, hᵢ that reflects not only the change amount of E(x) associated with the change in the value of xᵢ but also a change amount of P(x) is used. The following Expression (6) may represent hᵢ that reflects the change amount of P(x).

$$\begin{matrix}[ Expression 6 ] & \\ {h}_{i} = ( {\sum }_{j ∈ D} {W}_{ij} {x}_{j} + {b}_{i} ) - {\sum }_{k ∈ A} {λ}_{k} Δ g ( {h}_{k} , {W}_{ki} Δ {x}_{i} ) & ( 6 )\end{matrix}$$

In Expression (6), Δg(hₖ, WₖᵢΔxᵢ) is represented by the following Expression (7), and is an amount that may be calculated from Δxᵢ that is a change amount of the flip candidate state variable and hₖ and Wₖᵢ described above.

$$\begin{matrix}[ Expression 7 ] & \\ Δ g ( {h}_{k} , {W}_{ki} Δ {x}_{i} ) = Δ {x}_{i} [ g ( {h}_{k} + {W}_{ki} Δ {x}_{i} ) - g ( {h}_{k} ) ] & ( 7 )\end{matrix}$$

Furthermore, hᵢ represented by the following Expression (8) using xₖ representing presence or absence of violation of each of the constraint conditions may also be used as hᵢ.

$$\begin{matrix}[ Expression 8 ] & \\ {h}_{i} = {\sum }_{j ∈ D} {W}_{ij} {x}_{j} + {b}_{i} - {\sum }_{k ∈ A} {λ}_{k} {W}_{ki} {x}_{k} & ( 8 )\end{matrix}$$

The processing unit 12 calculates the change amount (ΔE) of E(x) in a case where a value of the flip candidate state variable changes. For example, ΔEᵢ in a case where the value of xᵢ changes may be calculated by an expression ΔEᵢ=−hᵢΔxᵢ based on hᵢ indicated by Expression (6) or (8).

Next, the processing unit 12 determines whether or not to permit a change in the value of the flip candidate state variable (whether or not flip is permissible) based on a result of comparison between max(0, ΔE) and a predetermined value. In the MCMC search, examples of the predetermined value include a noise value obtained based on a random number and a value of a temperature parameter. For example, −log(rand)×T, which is an example of a noise value obtained based on a uniform random number (rand) greater than 0 and less than 1 and a temperature parameter (T), may be used as the predetermined value. In this case, when max(0, ΔE)<−log(rand)×T is satisfied, the processing unit 12 determines that the change in the value of the flip candidate state variable is permitted (flip is permissible).

The processing of step S1b is performed as follows, for example.

In a case where it is determined that the flip is permissible, the processing unit 12 updates N pieces of hᵢ and E(x), in addition to xᵢ (state variables for which it is determined that the flip is permissible). Note that the processing unit 12 does not update xᵢ, hᵢ, and E(x) unless it is determined that the flip is permissible. The processing unit 12 updates E(x) by adding ΔE to the original E(x). Furthermore, for example, in a case where it is determined that flip is permissible for xⱼ, the processing unit 12 updates the N pieces of hᵢ by adding Δhᵢ=WᵢⱼΔxⱼ to the original hᵢ for each of the N state variables.

The processing of step S1c is performed as follows, for example.

The processing unit 12 determines whether or not to permit a change in a value of one (hereinafter referred to as a flip candidate auxiliary variable) of the M pieces of xₖ based on the change amount (ΔP) of P(x) in a case where the value of the flip candidate state variable changes. The processing unit 12 selects the flip candidate auxiliary variable at random or in a predetermined order, for example. The following Expression (9) may represent ΔPᵢ in a case where xₖ is selected.

$$\begin{matrix}[ Expression 9 ] & \\ Δ {P}_{i} = {λ}_{k} [ g ( {h}_{k} + {W}_{ki} Δ {x}_{i} ) - g ( {h}_{k} ) ] & ( 9 )\end{matrix}$$

Next, the processing unit 12 determines whether or not to permit a change in a value of the flip candidate auxiliary variable (whether or not flip is permissible) based on a result of comparison between ΔP and a predetermined value. The predetermined value may be a fixed value (for example, 0), or log(rand)×T may be used. For example, in a case where ΔP>0 or ΔP>log(rand)×T is satisfied, the processing unit 12 determines that the flip is permissible for the flip candidate auxiliary variable.

In a case where the constraint condition with the identification number=k is not satisfied due to the change in the value of the state variable by the processing of step S1b, ΔP becomes a positive value. The log(rand)×T is a negative value. Thus, xₖ is permitted to change from 0 to 1 by using the determination expression described above.

Note that, in a case where the auxiliary variable is not used, the processing of step S1c may be processing of determining whether or not the state of whether or not the constraint condition with the identification number=k is satisfied is made changeable based on a result of comparison between ΔP and the predetermined value described above, for example.

The processing of step S1d is performed as follows, for example.

In a case where it is determined that the flip is permissible for the flip candidate xₖ, the processing unit 12 updates xₖ, hₖ, hᵢ, P(x), and H(x). Note that the processing unit 12 does not update xₖ, hₖ, hᵢ, P(x), and H(x) unless it is determined that the flip is permissible.

In a case where it is determined that the flip is permissible for xⱼ as the state variable in the processing of step S1a described above, the processing unit 12 updates hₖ by adding Δhₖ=WₖⱼΔxⱼ to hₖ. Furthermore, in a case where hᵢ is represented as Expression (6), the processing unit 12 updates the N pieces of hᵢ based on hₖ before and after updating according to the following Expression (10).

$$\begin{matrix}[ Expression 10 ] & \\ {h}_{i} ← {h}_{i} ← {λ}_{k} [ Δ g ( {h}_{k} , {W}_{ki} Δ {x}_{i} ) - Δ g ( {h}_{k}^{( old )} , {W}_{ki} Δ {x}_{i} ) ] & ( 10 )\end{matrix}$$

In Expression (10), hₖ^{(old)} represents hₖ before updating. Note that, in a case where i=j is satisfied, hᵢ does not change, and thus updating is unnecessary.

In a case where hᵢ is represent as Expression (8), the processing unit 12 updates hᵢ by adding Δhᵢ=−λₖWₖᵢΔxₖ to the original hᵢ for each of the N state variables.

Moreover, the processing unit 12 updates P(x) by adding ΔP to the original P(x). Furthermore, the processing unit 12 updates H(x) by adding ΔH to the original H(x). In a case where the value of xᵢ changes, ΔHᵢ may be represented as ΔHᵢ=ΔEᵢ+ΔPᵢ.

Note that the processing unit 12 may repeat the processing of steps S1a and S1b a predetermined number of times, and then perform the processing of steps S1c and S1d. Furthermore, the processing unit 12 does not have to perform the processing of steps S1c and S1d until it is determined that the flip is permissible for the flip candidate state variable in the processing of step S1a and the update is performed in the processing of step S1b.

During the search processing as described above, the processing unit 12 determines whether or not it is an adjustment timing of λₖ (step S2). For example, the processing unit 12 determines that it is the adjustment timing each time the search processing described above is performed a predetermined number of times. In a case where it is determined that it is not the adjustment timing, the processing unit 12 repeats the processing from step S1. In a case where it is determined that it is the adjustment timing at a certain time point during the solution search, the processing unit 12 performs the following processing.

The processing unit 12 determines whether or not constraint violation occurs in any one of the M constraint conditions (step S3). For example, in a case where the value of P(x) is 0, the processing unit 12 determines that all the M constraint conditions are satisfied, and in a case where the value of P(x) is greater than 0, the processing unit 12 determines that the constraint violation occurs in any one of the M constraint conditions. The processing unit 12 performs the processing of step S4 in a case where it is determined that there is a constraint condition in which the constraint violation occurs, and performs the processing of step S5 in a case where it is determined that all the M constraint conditions are satisfied.

In the processing of step S4, the processing unit 12 individually increases the value of λₖ corresponding to the constraint condition in which the constraint violation occurs among the M constraint conditions. For example, the processing unit 12 increases the value of λₖ by adding Δλₖ₊ to λₖ. Thereafter, the processing of step S7 is performed.

In the processing of step S5, the processing unit 12 compares E(x) at the adjustment timing of λₖ with H(x) obtained before the adjustment timing of this time, and determines whether or not E(x) is improved. For example, in a case where E(x) at the adjustment timing of λₖ is smaller than a minimum value (hereinafter referred to as H_{best}) among the values of H(x) so far, the processing unit 12 determines that E(x) is improved.

In a case where it is determined that E(x) is improved, the processing unit 12 repeats the processing from step S1 while maintaining the values of λₖ corresponding to the M constraint conditions, and in a case where it is determined that E(x) is not improved, the processing unit 12 performs the processing of step S6.

In the processing of step S6, the processing unit 12 decreases the values of λₖ corresponding to the M constraint conditions, that is, all the values of λₖ. For example, the processing unit 12 decreases the values of all the pieces of λₖ by subtracting Δλₖ₋ corresponding to each λₖ from each λₖ.

Note that, for example, a value 0.1 times the original λₖ or the like is appropriately set as the value of Δλₖ₊ or Δλₖ₋. The values of Δλₖ₊ and Δλₖ₋ and the initial value of λₖ may be changed during the MCMC search. Furthermore, a method of adjusting the λₖ is not limited to the method described above, and the processing unit 12 may multiply λₖ by a predetermined value (for example, 1.1 or 0.9) to make adjustment.

After the processing of step S6, the processing of step S7 is performed. In the processing of step S7, the processing unit 12 performs correction of P(x). The correction of P(x) may be performed based on, for example, the following Expression (11) using Δλₖ that is the change amount of λₖ.

$$\begin{matrix}[ Expression 11 ] & \\ P ( x ) = P ( x ) + {\sum }_{k ∈ A} Δ {λ}_{k} ( {{\sum }_{i ∈ D}}_{k ∈ A} {W}_{ki} {x}_{i} - {U}_{k} ) {x}_{k} & ( 11 )\end{matrix}$$

For example, Δλₖ is Δλₖ₊ or Δλₖ₋ described above. Furthermore, Uₖ represents an upper limit of a resource amount, and Uₖ=−bₖ is satisfied.

Note that the correction of P(x) may be performed based on the following Expression (12) without using xₖ.

$$\begin{matrix}[ Expression 12 ] & \\ P ( x ) = P ( x ) + {\sum }_{k ∈ A} Δ {λ}_{k} max [ 0 , {h}_{k} ] & ( 12 )\end{matrix}$$

After the processing of step S7, the processing from step S1 is repeated.

Note that, in the above description, an example has been described in which the flip candidate state variables are selected one by one from the N state variables and the processing of steps S1a and S1b is performed, but the present disclosure is not limited to this. The processing of steps S1a and S1b may be performed in parallel for the plurality of (for example, all the N) state variables. In that case, when there is a plurality of state variables whose values are permitted to change, the processing unit 12 selects a state variable whose value is to be changed at random or according to a predetermined rule.

Similarly, in the above description, an example has been described in which the flip candidate auxiliary variables are selected one by one among the M state variables and the processing of steps S1c and S1d is performed, but the present disclosure is not limited to this. The processing of steps S1c and S1d may be performed in parallel for the plurality of (for example, all the M) state variables. In that case, when there is a plurality of auxiliary variables whose values are permitted to change, the processing unit 12 selects an auxiliary variable whose value is to be changed at random or according to a predetermined rule.

In a case where simulated annealing is performed, for example, the processing unit 12 decreases the value of the temperature parameter (T) described above according to a predetermined temperature parameter change schedule each time the flip determination for a state variable is repeated a predetermined number of times. Then, the processing unit 12 outputs a state obtained in a case where the flip determination is repeated the predetermined number of times as a calculation result of the combinatorial optimization problem (for example, displays the state on a display device (not illustrated)). Note that the processing unit 12 may cause the storage unit 11 to hold H_{best} described above and a state when H_{best} is obtained (combination of values of the N state variables). In that case, the processing unit 12 may output, as the calculation result, a state corresponding to H_{best} stored after the flip determination is repeated the predetermined number of times.

In a case where the processing unit 12 performs a replica exchange method, the processing unit 12 repeats the processing of Steps S1 to S7 described above for each of a plurality of replicas to which each different T value is set. Then, the processing unit 12 performs replica exchange each time the flip determination for a state variable is repeated a predetermined number of times. For example, the processing unit 12 selects two replicas having adjacent T values, and exchanges the values of the respective state variables and the values of the respective auxiliary variables between the selected two replicas at a predetermined exchange probability based on an energy difference or a T value difference between the replicas. Note that the T values may be exchanged between the two replicas instead of the values of the respective state variables and the values of the respective auxiliary variables. Alternatively, the processing unit 12 causes the storage unit 11 to hold H_{best} and the state when H_{best} is obtained. Then, the processing unit 12 outputs, as a calculation result, a state corresponding to the smallest H_{best} in all the replicas among the pieces of H_{best} stored after the flip determination described above is repeated the predetermined number of times in the respective replicas.

As described above, the data processing device 10 includes the storage unit 11 and the processing unit 12. The storage unit 11 stores the evaluation function information. The evaluation function information is information regarding the evaluation function (H(x)) of the combinatorial optimization problem represented by the sum of the quadratic cost term (E(x)) and the linear cost term (P(x)) that is the sum of the plurality of constraint terms weighted by the coefficient (λₖ) representing the weight of each of the plurality of constraint conditions. The processing unit 12 acquires the evaluation function information from the storage unit 11, and searches for a solution to the combinatorial optimization problem based on the evaluation function information. Then, in a case where there is a first constraint condition in which the constraint violation occurs among the plurality of constraint conditions at a first time point (the adjustment timing described above) during the solution search, the processing unit 12 increases the value of λₖ corresponding to the first constraint condition. In a case where all of the plurality of constraint conditions are satisfied at the first time point, the processing unit 12 compares the value of E(x) at the first time point with the value of H(x) obtained before the first time point (for example, H_{best}). Then, the processing unit 12 determines whether to decrease or maintain the value of λₖ corresponding to the plurality of constraint conditions based on a result of the comparison.

By adjusting λₖ as described above, λₖ may be appropriately adjusted by reflecting a solution search situation (for example, a situation as to whether or not E(x) is improved) and a constraint satisfaction situation, so that efficiency in searching for a solution to the combinatorial optimization problem may be improved.

For example, according to an adjustment method of λₖ according to the present embodiment, in a case where there is a constraint condition in which the constraint violation occurs among the plurality of constraint conditions at the adjustment timing, the value of λₖ corresponding to the constraint condition is increased. As a result, occurrence of a constraint violation solution for the constraint condition may be suppressed, and the efficiency in searching for the solution is improved. Furthermore, according to the adjustment method of λₖ according to the present embodiment, in a case where all of the plurality of constraint conditions are satisfied, whether to maintain or decrease the value of λₖ is determined based on the result of comparison between the value of E(x) at the adjustment timing and the value of H(x) obtained before the adjustment timing. For example, when the value of E(x) at the adjustment timing is equal to or greater than H_{best}, the value of λₖ corresponding to the plurality of constraint conditions is decreased, so that a state transition is promoted, and the search efficiency is improved. When the value of E(x) at the adjustment timing is smaller than H_{best}, it is sufficient that the processing unit 12 maintains the current value of λₖ. This is because there is a high possibility that the current value of λₖ is appropriate.

Furthermore, the adjustment method of λₖ according to the present embodiment does not uniformly decrease all the pieces of λₖ in a case where all the plurality of constraint conditions are satisfied (in a case where no constraint violation occurs), and thus, it is possible to suppress an operation amount.

Furthermore, the adjustment method of λₖ according to the present embodiment does not uniformly decrease all the pieces of λₖ when the value of E(x) is equal to or greater than H_{best}. The adjustment method of λₖ according to the present embodiment determines whether to decrease or maintain all the values of λₖ based on the value of E(x) and, for example, the result of comparison of H_{best} in a case where all the constraint conditions are satisfied. As a result, even though constraint violation of a certain constraint condition occurs, λₖ for the constraint condition is not decreased. As a result, it is possible to lower the possibility of the occurrence of the constraint violation solution, and to suppress the deterioration of the search efficiency.

Furthermore, in a case where λₖ is adjusted, P(x) is corrected based on the change amount of λₖ, whereby occurrence of a calculation error caused by changing of λₖ may be suppressed. Note that, in a case where λₖ is adjusted, it is conceivable to correct the N pieces of hᵢ, but the operation amount may be reduced by correcting P(x) as described above instead.

Such a data processing device 10 may be expected to be useful as a technique for suppressing an operation amount and an amount of hardware materials and efficiently obtaining an accurate solution when solving various problems in modern society that may be converted into a combinatorial optimization problem having a constraint condition.

### Second Embodiment

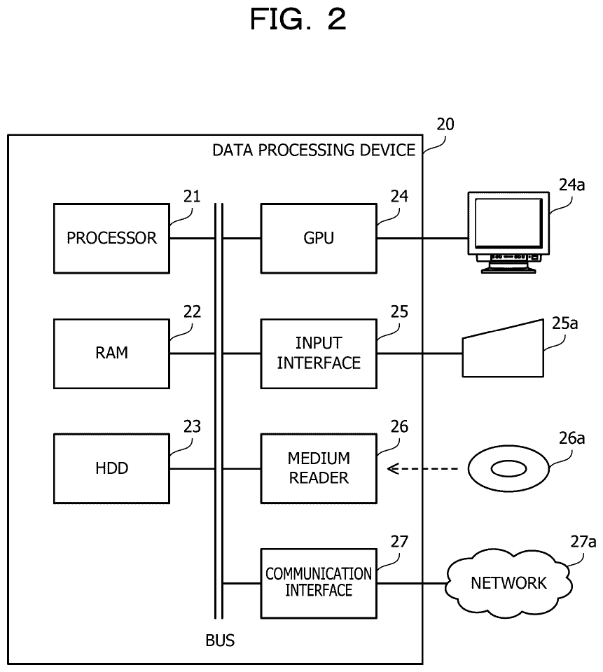

FIG. 2 is a block diagram illustrating a hardware example of a data processing device of a second embodiment.

A data processing device 20 is, for example, a computer and includes a processor 21, a random access memory (RAM) 22, an HDD 23, a GPU 24, an input interface 25, a medium reader 26, and a communication interface 27. The units described above are coupled to a bus.

The processor 21 is a processor such as a GPU or a CPU including an arithmetic circuit that executes a program command. The processor 21 loads at least a part of a program and data stored in the HDD 23 into the RAM 22, and executes the program. Note that the processor 21 may include a plurality of processor cores. Furthermore, the data processing device 20 may include a plurality of processors. Note that a set of the plurality of processors (multiprocessor) may be referred to as a “processor”.

The RAM 22 is a volatile semiconductor memory that temporarily stores a program to be executed by the processor 21 and data to be used by the processor 21 for arithmetic operations. Note that the data processing device 20 may include a memory of a type other than the RAM 22, or may include a plurality of memories.

The HDD 23 is a non-volatile storage device that stores programs of software such as an operating system (OS), middleware, and application software, and data. The programs include, for example, a program for causing the data processing device 20 to execute processing of searching for a solution to a combinatorial optimization problem. Note that the data processing device 20 may include another type of storage device such as a flash memory or a solid state drive (SSD), or may include a plurality of non-volatile storage devices.

The GPU 24 outputs an image to a display 24a coupled to the data processing device 20 according to a command from the processor 21. As the display 24a, a cathode ray tube (CRT) display, a liquid crystal display (LCD), a plasma display panel (PDP), an organic electro-luminescence (OEL) display, or the like may be used.

The input interface 25 acquires input signals from an input device 25a coupled to the data processing device 20, and outputs the input signals to the processor 21. As the input device 25a, a pointing device such as a mouse, a touch panel, a touch pad, or a trackball, a keyboard, a remote controller, a button switch, or the like may be used. Furthermore, a plurality of types of input devices may be coupled to the data processing device 20.

The medium reader 26 is a reading device that reads a program and data recorded on a recording medium 26a. As the recording medium 26a, for example, a magnetic disk, an optical disk, a magneto-optical disk (MO), a semiconductor memory, or the like may be used. The magnetic disk includes a flexible disk (FD) and an HDD. The optical disk includes a compact disc (CD) and a digital versatile disc (DVD).

The medium reader 26 copies, for example, a program and data read from the recording medium 26a to another recording medium such as the RAM 22 or the HDD 23. The read program is executed by, for example, the processor 21. Note that the recording medium 26a may be a portable recording medium, and may be used for distribution of the program and data. Furthermore, the recording medium 26a and the HDD 23 may be referred to as computer-readable recording media.

The communication interface 27 is an interface that is coupled to a network 27a and communicates with another information processing device via the network 27a. The communication interface 27 may be a wired communication interface coupled to a communication device such as a switch by a cable, or may be a wireless communication interface coupled to a base station via a wireless link.

Next, functions and processing procedures of the data processing device 20 will be described.

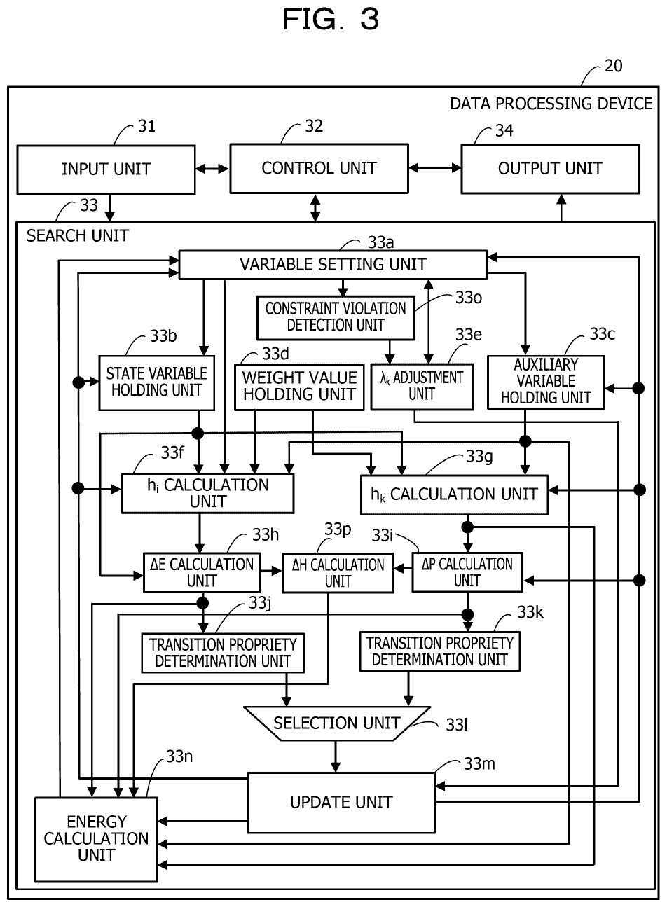

FIG. 3 is a block diagram illustrating a functional example of the data processing device.

The data processing device 20 includes an input unit 31, a control unit 32, a search unit 33, and an output unit 34. With these units, processing similar to the processing performed by the processing unit 12 illustrated in FIG. 1 is performed. Note that various types of information such as the evaluation function information stored in the storage unit 11 illustrated in FIG. 1 are stored in, for example, various holding units or the like to be described later included in the search unit 33. In other words, the search unit 33 may include the function of the storage unit 11 illustrated in FIG. 1. Note that the data processing device 20 may have a functional block corresponding to the storage unit 11 separately from the search unit 33.

The input unit 31, the control unit 32, the search unit 33, and the output unit 34 may be implemented by using, for example, a program module to be executed by the processor 21 or a storage area (register or cache memory) in the processor 21. Note that the search unit 33 may be further implemented by using a storage area secured in the RAM 22 or the HDD 23.

The input unit 31 receives, for example, input of initial values of N state variables, evaluation function information, and calculation conditions. The evaluation function information includes, for example, Wₖᵢ and bₖ in Expression (4) in addition to Wᵢⱼ and bᵢ in Expression (2). The calculation conditions include, for example, the number of replicas, a replica exchange cycle, and a value of a temperature parameter set for each replica in a case where the replica exchange method is executed, a temperature parameter change schedule in a case where the simulated annealing is performed, calculation end conditions, and the like.

Moreover, the calculation conditions include a parameter for adjusting λₖ. Examples of the parameter for adjusting λₖ include an initial value of λₖ (λₖᵢₙᵢₜ), an increase amount (Δλₖ₊) and a decrease amount (Δλₖ₋) of λₖ, a variable (T1) indicating an interval for setting λₖᵢₙᵢₜ, Δλₖ₊, and Δλₖ₋, and a variable (T0) indicating an adjustment interval of λₖ. Note that T1>T0 is satisfied.

Furthermore, the input unit 31 may receive input of an initial value of hᵢ in Expression (6) or Expression (8) or an initial value of hₖ in Expression (3). In a case where M auxiliary variables are used, the input unit 31 may receive input of initial values of the M auxiliary variables.

These pieces of information may be input by an operation of the input device 25a made by a user, or may be input via the recording medium 26a or the network 27a.

The control unit 32 controls each unit of the data processing device 20 to execute processing to be described later.

The search unit 33 repeats an MCMC search under the control of the control unit 32, thereby searching for a state where a value (total energy) of an evaluation function is minimized.

The output unit 34 outputs a search result (calculation result) by the search unit 33.

For example, the output unit 34 may output the calculation result to the display 24a to be displayed, transmit the calculation result to another information processing device via the network 27a, or store the calculation result in an external storage device.

The search unit 33 includes a variable setting unit 33a, a state variable holding unit 33b, an auxiliary variable holding unit 33c, a weight value holding unit 33d, and a λₖ adjustment unit 33e. Moreover, the search unit 33 includes an hᵢ calculation unit 33f, an hₖ calculation unit 33g, a ΔE calculation unit 33h, a ΔP calculation unit 33i, transition propriety determination units 33j and 33k, a selection unit 33l, an update unit 33m, an energy calculation unit 33n, a constraint violation detection unit 33o, and a ΔH calculation unit 33p.

The variable setting unit 33a holds various variables (λₖ, the parameter for adjusting λₖ described above, and the like) received by the input unit 31, and sets them in the respective units. The variable setting unit 33a may hold E(x), H_{best}, and the like to be used to determine whether to increase or decrease λₖ. Furthermore, the variable setting unit 33a may hold P(x) used by the constraint violation detection unit 33o to detect occurrence of constraint violation.

The state variable holding unit 33b holds the N state variables (xᵢ). Furthermore, the state variable holding unit 33b outputs a change amount (Δxᵢ) of xᵢ of a flip candidate.

The auxiliary variable holding unit 33c holds the M auxiliary variables. Note that, in a case where the data processing device 20 does not use the auxiliary variable, the auxiliary variable holding unit 33c does not have to be provided.

The weight value holding unit 33d holds weight values (Wᵢⱼ) between the N state variable and weight values (Wₖᵢ) representing a weight of xᵢ in each of the N state variables and M inequality constraints. Wᵢⱼ may be represented by a matrix of N rows and N columns, and Wₖᵢ may be represented by a matrix of M rows and N columns. Note that it is not needed to hold a weight value between state variables that do not affect any one of the M inequality constraints among the N state variables and the M inequality constraints.

The λₖ adjustment unit 33e performs adjustment processing of a value of λₖ each time search processing (MCMC search) is performed TO times. The λₖ adjustment unit 33e supplies the adjusted λₖ to the variable setting unit 33a, and supplies Δλₖ to the update unit 33m.

The hᵢ calculation unit 33f holds N pieces of hᵢ, and updates hᵢ according to changes in values of the state variables and the auxiliary variables.

The hₖ calculation unit 33g holds M pieces of hₖ and updates hₖ according to changes in the values of the state variables.

The ΔE calculation unit 33h calculates ΔE represented by an expression ΔE=−hᵢΔxᵢ.

The ΔP calculation unit 33i calculates ΔP represented by Expression (9) described above.

The transition propriety determination unit 33j performs flip determination processing to determine whether or not to permit a change in a value of a flip candidate state variable based on a result of comparison between ΔE output by the ΔE calculation unit 33h and a predetermined value. Examples of the predetermined value include a noise value obtained based on a random number and a value of a temperature parameter. In a case where max(0, ΔE)<−log(rand)×T is satisfied, the transition propriety determination unit 33j determines that the change in the value of the flip candidate state variable is permitted (flip is permissible).

The transition propriety determination unit 33k performs flip determination processing to determine whether or not to permit a change in a value of a flip candidate auxiliary variable based on a result of comparison between ΔP output by the ΔP calculation unit 33i and a predetermined value. The predetermined value may be a fixed value (for example, 0), or log(rand)×T may be used. For example, in a case where ΔP>0 or ΔP>log(rand)×T is satisfied, the transition propriety determination unit 33k determines that flip is permissible for the flip candidate auxiliary variable.

The selection unit 33l selects a determination result of the transition propriety determination unit 33j in the case of performing flip determination for a state variable, and selects a determination result of the transition propriety determination unit 33k in the case of performing the flip determination for an auxiliary variable, and outputs the determination result.

The update unit 33m transmits an identification number of the state variable for which it is determined that the flip is permissible to the state variable holding unit 33b, and changes a value of the state variable. Furthermore, the update unit 33m transmits an identification number of the auxiliary variable for which it is determined that the flip is permissible to the auxiliary variable holding unit 33c, and changes a value of the auxiliary variable.

Moreover, in a case where it is determined that the flip is permissible for the flip candidate state variable, the update unit 33m causes the hᵢ calculation unit 33f and the hₖ calculation unit 33g to update the N pieces of hᵢ and the M pieces of hₖ. In a case where it is determined that the flip is permissible for the flip candidate auxiliary variable, the update unit 33m causes the hᵢ calculation unit 33f to update the N pieces of hᵢ.

Furthermore, in a case where it is determined that the flip is permissible for the state variable or the auxiliary variable, the update unit 33m causes the energy calculation unit 33n to update a value of E(x), P(x), or H(x). Furthermore, when λₖ is adjusted, the update unit 33m supplies Δλₖ to the energy calculation unit 33n to correct P(x).

The energy calculation unit 33n holds the values of E(x), P(x), and H(x), and updates these values in a case where an update instruction is issued from the update unit 33m. Moreover, in a case where a P(x) correction instruction is issued from the update unit 33m, the energy calculation unit 33n corrects P(x) based on Δλₖ according to Expression (11) or Expression (12) described above.

Furthermore, the energy calculation unit 33n holds H_{best}, and in a case where the updated H(x) is smaller than H_{best} and no constraint condition violation occurs when the H(x) is obtained, the energy calculation unit 33n sets the H(x) as a new H_{best}.

The constraint violation detection unit 330 detects constraint violation based on P(x) held in the variable setting unit 33a. In a case where P(x)>0 is satisfied, the constraint violation detection unit 33o determines that constraint violation occurs in any one of the M constraint conditions, and outputs a signal (Flag) indicating that the constraint violation occurs. Hereinafter, it is assumed that the constraint violation detection unit 330 outputs Flag=1 in a case where P(x)>0 is satisfied, and outputs Flag=0 in a case where P(x)=0 is satisfied (that is, in a case where the constraint violation does not occur).

The ΔH calculation unit 33p receives ΔE from the ΔE calculation unit 33h, receives ΔP from the ΔP calculation unit 33i, and calculates and outputs ΔH=ΔE+ΔP. The calculated ΔH is supplied to the energy calculation unit 33n for updating H(x).

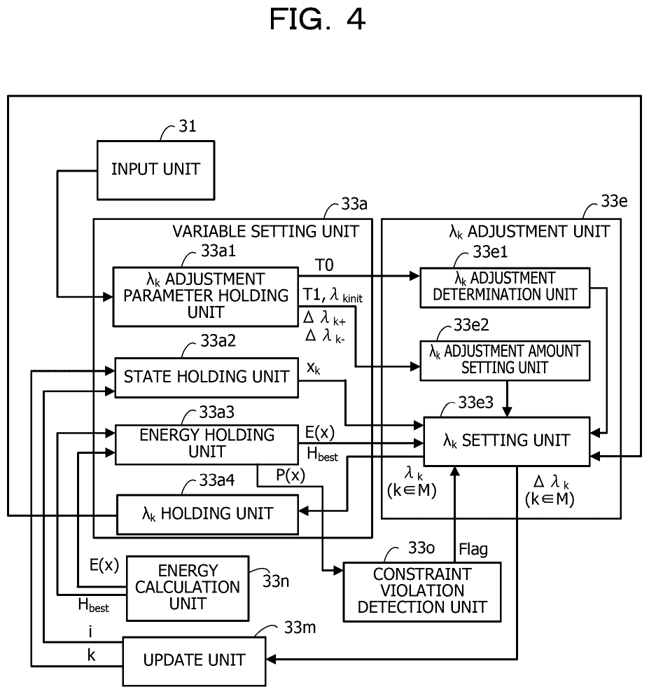

FIG. 4 is a diagram illustrating an example of the variable setting unit and the λₖ adjustment unit. In FIG. 4, an example of a case where the auxiliary variable is used is illustrated.

The variable setting unit 33a includes a λₖ adjustment parameter holding unit 33a1, a state holding unit 33a2, an energy holding unit 33a3, and a λₖ holding unit 33a4. The λₖ adjustment parameter holding unit 33a1, the state holding unit 33a2, the energy holding unit 33a3, and the λₖ holding unit 33a4 may be implemented by using a storage circuit such as a register.

The λₖ adjustment unit 33e includes a λₖ adjustment determination unit 33e1, a λₖ adjustment amount setting unit 33e2, and a λₖ setting unit 33e3.

The λₖ adjustment parameter holding unit 33a1 holds T0, T1 (>0), λₖᵢₙᵢₜ, Δλₖ₊, and Δλₖ₋. The λₖ adjustment parameter holding unit 33a1 supplies T0 to the λₖ adjustment determination unit 33e1, and supplies T1, λₖᵢₙᵢₜ, Δλₖ₊, and Δλₖ₋ to the λₖ adjustment amount setting unit 33e2.

The state holding unit 33a2 holds the values of the state variables and the auxiliary variables. In a case where an identification number i of the state variable for which it is determined that the flip is permissible is received from the update unit 33m, the state holding unit 33a2 changes the value of the state variable (xᵢ) corresponding to the identification number i. In a case where an identification number k of the auxiliary variable for which it is determined that the flip is permissible is received from the update unit 33m, the state holding unit 33a2 changes the value of the auxiliary variable (xₖ) corresponding to the identification number k. The state holding unit 33a2 supplies M pieces of xₖ to the λₖ setting unit 33e3.

The energy holding unit 33a3 receives E(x), P(x), and H_{best} from the energy calculation unit 33n, and holds them. The energy holding unit 33a3 supplies E(x) and H_{best} to the λₖ setting unit 33e3. The energy holding unit 33a3 supplies P(x) to the constraint violation detection unit 33o.

The λₖ holding unit 33a4 holds the initial value of λₖ in all the constraint conditions. Thereafter, the λₖ holding unit 33a4 holds λₖ (k∈M) obtained by the λₖ setting unit 33e3 at an adjustment timing of λₖ.

The λₖ adjustment determination unit 33e1 determines that it is the adjustment timing of λₖ each time the MCMC search is performed T0 times.

The λₖ adjustment amount setting unit 33e2 sets λₖᵢₙᵢₜ, Δλₖ₊, and Δλₖ₋ in the λₖ setting unit 33e3 each time the MCMC search is performed T1 times. As a result, λₖ is initialized.

In a case where Flag=1 is satisfied for the Flag output by the constraint violation detection unit 33o, the λₖ setting unit 33e3 specifies a constraint condition in which xₖ=1 is satisfied (constraint violation occurs) among the M pieces of xₖ. Then, Δλₖ₊ is added to the value of λₖ (held by the λₖ holding unit 33a4) of the specified constraint condition.

In a case where Flag=0 is satisfied for the Flag output by the constraint violation detection unit 33o, the λₖ setting unit 33e3 compares E(x) with H_{best}. Then, in a case where E(x) is equal to or greater than H_{best}, the λₖ setting unit 33e3 decreases all the values of the M pieces of λₖ by subtracting Δλₖ₋ corresponding to each λₖ from each λₖ. In a case where E(x) is smaller than H_{best}, the λₖ setting unit 33e3 maintains the values of the M pieces of λₖ.

In a case where the value of λₖ is adjusted, the λₖ setting unit 33e3 outputs, as Δλₖ, the value used for the adjustment out of Δλₖ₋ and Δλₖ₊.

Note that, in the data processing device 20, in a case where the auxiliary variable is not used, the variable setting unit 33a may hold hₖ instead of xₖ. In that case, when hₖ>0 is satisfied, the λₖ setting unit 33e3 determines that the constraint violation occurs in the constraint condition with the identification number=k.

Hereinafter, an example of a processing procedure (data processing method) of the data processing device 20 will be described.

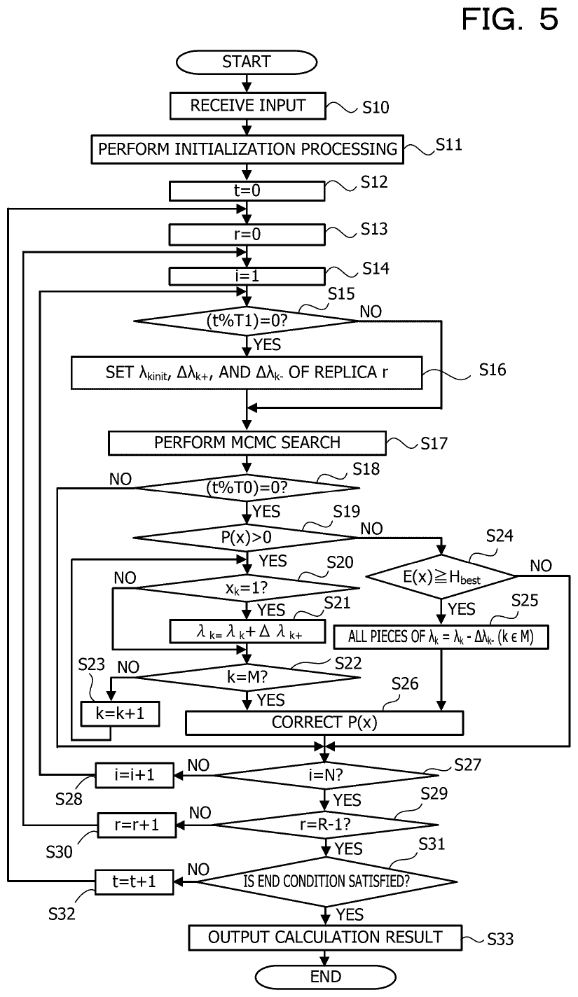

FIG. 5 is a flowchart illustrating a flow of an example of the data processing method. Hereinafter, an example using the auxiliary variable (xₖ) will be described, but hₖ may also be used instead of xₖ.

Step S10: The input unit 31 receives input of initial values of N state variables, initial values of M auxiliary variables, evaluation function information, and calculation conditions.

Step S11: The control unit 32 performs initialization processing. In the initialization processing, for example, the following processing is performed. The control unit 32 causes the variable setting unit 33a and the state variable holding unit 33b to hold the initial values of the N state variables, and causes the variable setting unit 33a and the auxiliary variable holding unit 33c to hold the initial values of the M auxiliary variables. Furthermore, the control unit 32 causes the weight value holding unit 33d to hold a weight value included in the evaluation function information, and causes the variable setting unit 33a to hold a parameter for adjusting λₖ of the calculation conditions.

Moreover, the control unit 32 calculates an initial value of hᵢ indicated by Expression (6) or Expression (8) and an initial value of hₖ indicated by Expression (4) based on the initial values of the N state variables, the initial values of the M auxiliary variables, and the evaluation function information. The control unit 32 causes the hᵢ calculation unit 33f to hold the calculated initial values of the N pieces of hᵢ, and causes the hₖ calculation unit 33g to hold the calculated initial values of the M pieces of hₖ.

Furthermore, the control unit 32 calculates, for example, an initial value of E(x) indicated by Expression (2), an initial value of P(x) indicated by Expression (3), and an initial value H(x) indicated by Expression (1) based on the initial values of the N state variables, the initial values of the M auxiliary variables, and the evaluation function information. The control unit 32 causes the energy calculation unit 33n and the energy holding unit 33a3 to hold the calculated initial values of E(x) and P(x).

Moreover, in the initialization processing, the number of replicas=R and the like are set in the variable setting unit 33a.

Step S12: The control unit 32 sets t=0. A variable representing the number of MCMC searches is represented by t. In the following example, it is assumed that the number of MCMC searches is counted as one in a case where the MCMC search is performed for each of the N state variables.

Step S13: The control unit 32 sets r=0. A variable representing a replica number is represented by r.

Step S14: The control unit 32 sets i=1. An identification number of the state variable is represented by i.

Step S15: The λₖ adjustment amount setting unit 33e2 of the λₖ adjustment unit 33e determines whether or not a variable (T1) indicating an interval for setting λₖᵢₙᵢₜ, Δλₖ₊, and Δλₖ₋ is divisible by t (whether or not (t % T1)=0). In a case where it is determined that (t % T1)=0 is satisfied, processing of step S16 is performed, and in a case where it is determined that t % T1=0 is not satisfied, processing of step S17 is performed.

Step S16: The λₖ adjustment amount setting unit 33e2 sets λₖᵢₙᵢₜ, Δλₖ₊, and Δλₖ₋ of a replica with the replica number=r (hereinafter referred to as a replica r) for the λₖ setting unit 33e3. As a result, λₖ is initialized to λₖᵢₙᵢₜ. Note that values of Δλₖ₊ and Δλₖ₋ may be changed.

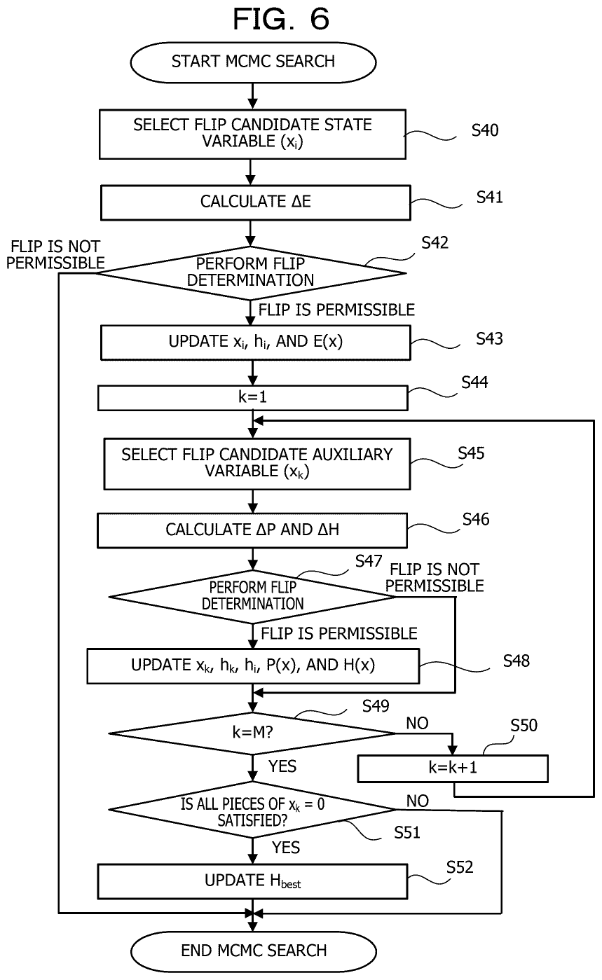

Step S17: The search unit 33 performs the MCMC search. A processing procedure of the MCMC search will be described later (see FIG. 6).

Step S18: The λₖ adjustment determination unit 33e1 of the λₖ adjustment unit 33e determines whether or not a variable (T0) indicating an adjustment interval of λₖ is divisible by t (whether or not (t % T0)=0). In a case where it is determined that t % T0=0 is satisfied, processing of step S19 is performed, and in a case where it is determined that t % T0=0 is not satisfied, processing of step S27 is performed.

Step S19: The constraint violation detection unit 33o determines whether or not P(x)>0 is satisfied. In a case where it is determined that P(x)>0 is satisfied, processing of step S20 is performed after setting k=1 although not illustrated, and in a case where it is determined that P(x)>0 is not satisfied, processing of step S24 is performed.

Step S20: The λₖ setting unit 33e3 determines whether or not xₖ=1 is satisfied. In a case where it is determined that xₖ=1 is satisfied, processing of step S21 is performed, and in a case where it is determined that xₖ=1 is not satisfied, processing of step S22 is performed. Note that, in a case where the auxiliary variable is not used, the λₖ setting unit 33e3 may determine whether or not hₖ>0 is satisfied instead of determining whether or not xₖ=1 is satisfied. In that case, the processing of step S21 is performed in a case where it is determined that hₖ>0 is satisfied, and the processing of step S22 is performed in a case where it is determined that hₖ>0 is not satisfied.

Step S21: The λₖ setting unit 33e3 adjusts λₖ by adding Δλₖ₊ to the original λₖ.

Step S22: The control unit 32 determines whether or not k=M is satisfied. In a case where it is determined that k=M is satisfied, processing of Step S26 is performed, and in a case where it is determined that k=M is not satisfied, processing of Step S23 is performed.

Step S23: The control unit 32 sets k=k+1. Thereafter, the processing from step S20 is repeated.

Step S24: The λₖ setting unit 33e3 of the λₖ adjustment unit 33e determines whether or not E(x)≥H_{best} is satisfied. In a case where it is determined that E(x)≥H_{best} is satisfied, processing of step S25 is performed, and in a case where it is determined that E(x)≥H_{best} is not satisfied, processing of step S27 is performed.

Step S25: The λₖ setting unit 33e3 adjusts λₖ by subtracting Δλₖ₋ from all the pieces of λₖ.

Step S26: Correction of P(x) is performed. The energy calculation unit 33n corrects P(x) according to, for example, Expression (11).

Step S27: The control unit 32 determines whether or not i=N is satisfied. In a case where it is determined that i=N is satisfied, processing of step S29 is performed, and in a case where it is determined that i=N is not satisfied, processing of step S28 is performed.

Step S28: The control unit 32 sets i=i+1. Thereafter, the processing from step S15 is repeated.

Step S29: The control unit 32 determines whether or not r=R−1 is satisfied. In a case where it is determined that r=R−1 is satisfied, processing of step S31 is performed, and in a case where it is determined that r=R−1 is not satisfied, processing of step S30 is performed.

Step S30: The control unit 32 sets r=r+1. Thereafter, the processing from step S14 is repeated.

Step S31: The control unit 32 determines whether or not an end condition is satisfied. For example, the control unit 32 determines that the end condition is satisfied in a case where the number of MCMC searches (t) reaches the maximum number of times or in a case where H_{best} becomes equal to or smaller than predetermined magnitude. In a case where it is determined that the processing satisfies the predetermined end condition, processing of Step S33 is performed, and in a case where it is determined that the processing does not satisfy the predetermined end condition, processing of Step S32 is performed.

Step S32: The control unit 32 sets t=t+1. Thereafter, the processing from step S13 is repeated.

Step S33: The output unit 34 outputs a calculation result. As a result, the processing ends. For example, the output unit 34 may output the calculation result to the display 24a to be displayed, transmit the calculation result to another information processing device via the network 27a, or store the calculation result in an external storage device.

Note that, in a case where the simulated annealing is performed, for example, the control unit 32 decreases the value of the temperature parameter (T) described above according to a predetermined temperature parameter change schedule each time the MCMC search for the state variable is repeated a predetermined number of times. Then, under the control of the control unit 32, the output unit 34 outputs, as a calculation result, a state corresponding to the minimum value of H_{best} of the respective replicas obtained in a case where the MCMC search is repeated the maximum number of times, for example.

In a case where the replica exchange method is performed, replica exchange is performed each time the MCMC search is repeated a predetermined number of times. For example, the control unit 32 selects two replicas having adjacent T values, and exchanges the T values or the values of the respective state variables and the values of the respective auxiliary variables between the selected two replicas at a predetermined exchange probability based on an H(x) difference or a T value difference between the replicas. Then, under the control of the control unit 32, the output unit 34 outputs, as a calculation result, a state corresponding to the minimum value of H_{best} of the respective replicas obtained in a case where the MCMC search is repeated the maximum number of times, for example.

FIG. 6 is a flowchart illustrating a flow of an example of the processing procedure of the MCMC search.

Step S40: A flip candidate state variable (xᵢ) is selected. When the flip candidate state variable is selected, a change amount (Δxᵢ) when a value of the state variable is changed is output from the state variable holding unit 33b.

Step S41: The ΔE calculation unit 33h of the search unit 33 calculates ΔE by the expression ΔE=−hᵢΔxᵢ.

Step S42: The transition propriety determination unit 33j of the search unit 33 performs flip determination for xᵢ based on a result of comparison between ΔE and the predetermined value described above. In a case where it is determined that a change in xᵢ is permitted (in a case where “flip is permissible”), processing of step S43 is performed, and in a case where it is determined that a change in xᵢ is not permitted (in a case where “flip is not permissible”), one MCMC search is ended.

Step S43: The search unit 33 updates xᵢ, hᵢ, and E(x) by the processing described above.

Step S44: The control unit 32 sets k=1.

Step S45: A flip candidate auxiliary variable (xₖ) is selected. When the flip candidate auxiliary variable is selected, a change amount (Δxₖ) when a value of the auxiliary variable is changed is output from the auxiliary variable holding unit 33c. Note that, in a case where the auxiliary variable is not used, the processing of step S45 does not have to be performed.

Step S46: The ΔP calculation unit 33i of the search unit 33 calculates ΔP according to Expression (9). Moreover, the ΔH calculation unit 33p calculates ΔH=ΔE+ΔP.

Step S47: The transition propriety determination unit 33k of the search unit 33 performs flip determination for xₖ based on a result of comparison between ΔP and the predetermined value described above, for example. In a case where it is determined that a change in xₖ is permitted (in a case where “flip is permissible”), processing of Step S48 is performed, and in a case where it is determined that a change in xₖ is not permitted (in a case where “flip is not permissible”), processing of Step S49 is performed. Note that, in a case where the auxiliary variable is not used, the processing of step S47 may be processing of determining whether or not a state of whether or not the constraint condition with the identification number=k is satisfied is made changeable based on the result of comparison between ΔP and the predetermined value described above, for example.

Step S48: The search unit 33 updates xₖ, hₖ, hᵢ, P(x), and H(x) by the processing described above.

Step S49: The control unit 32 determines whether or not k=M is satisfied. In a case where it is determined that k=M is satisfied, processing of Step S51 is performed, and in a case where it is determined that k=M is not satisfied, processing of Step S50 is performed.

Step S50: The control unit 32 sets k=k+1. Thereafter, the processing from Step S45 is repeated.

Step S51: The control unit 32 determines whether or not all the pieces of xₖ are 0. In a case where it is determined that all the pieces of xₖ are 0, processing of step S52 is performed. In a case where it is determined that all the pieces of xₖ are not 0 (any one xₖ is not 0), one MCMC search is ended.

Step S52: The energy calculation unit 33n updates H_{best}. In a case where the updated H(x) is smaller than H_{best}, the energy calculation unit 33n sets the H(x) as a new H_{best}. After the processing of step S52, one MCMC search is ended.

Note that the order of the processing illustrated in FIGS. 5 and 6 is an example, and the order of the processing may be appropriately changed. Furthermore, while it is assumed that the flip candidate state variables and the flip candidate auxiliary variables are selected in the order of identification numbers in the processing example described above, they may be selected at random.

As described above, in a case where there is the constraint condition in which the constraint violation occurs among the M constraint conditions at the adjustment timing of λₖ that arrives each time the MCMC search is performed TO times, the data processing device 20 increases the value of λₖ corresponding to the constraint condition. Furthermore, in a case where all the M constraint conditions are satisfied at the adjustment timing of λₖ, the data processing device 20 compares the value of E(x) at the adjustment timing with H_{best}. The data processing device 20 determines whether to decrease or maintain the value of λₖ corresponding to the M constraint conditions based on the result of comparison.

By adjusting λₖ as described above, λₖ may be appropriately adjusted by reflecting a solution search situation and a constraint satisfaction situation, so that efficiency in searching for a solution to a combinatorial optimization problem may be improved similarly to the data processing device 10 of the first embodiment.

Furthermore, the adjustment method of λₖ according to the present embodiment does not uniformly decrease all the pieces of λₖ in a case where all the plurality of constraint conditions are satisfied (in a case where no constraint violation occurs), and thus, it is possible to suppress an operation amount.

Furthermore, the adjustment method of λₖ according to the present embodiment does not uniformly decrease all the pieces of λₖ when the value of E(x) is equal to or greater than H_{best}. The adjustment method of λₖ according to the present embodiment determines whether to decrease or maintain all the values of λₖ based on the value of E(x) and, for example, the result of comparison of H_{best} in a case where all the constraint conditions are satisfied. As a result, even though constraint violation of a certain constraint condition occurs, λₖ for the constraint condition is not decreased. As a result, it is possible to lower a possibility of occurrence of a constraint violation solution, and to suppress deterioration of the search efficiency.

Furthermore, in a case where λₖ is adjusted, P(x) is corrected based on an adjustment amount of λₖ, whereby occurrence of a calculation error caused by changing of λₖ may be suppressed. Note that, in a case where λₖ is adjusted, it is conceivable to correct hᵢ, but the operation amount may be reduced by correcting P(x) as in the processing of step S26 instead.

Note that, as described above, the processing contents described above may be implemented by causing the data processing device 20 to execute a program.

The program may be recorded in a computer-readable recording medium (for example, the recording medium 26a). As the recording medium, for example, a magnetic disk, an optical disk, a magneto-optical disk, a semiconductor memory, or the like may be used. Examples of the magnetic disk include an FD and an HDD. Examples of the optical disk include a CD, a CD-recordable (R)/rewritable (RW), a DVD, and a DVD-R/RW. The program may be recorded in a portable recording medium and distributed. In that case, the program may be copied from the portable recording medium to another recording medium (for example, the HDD 23) and executed.

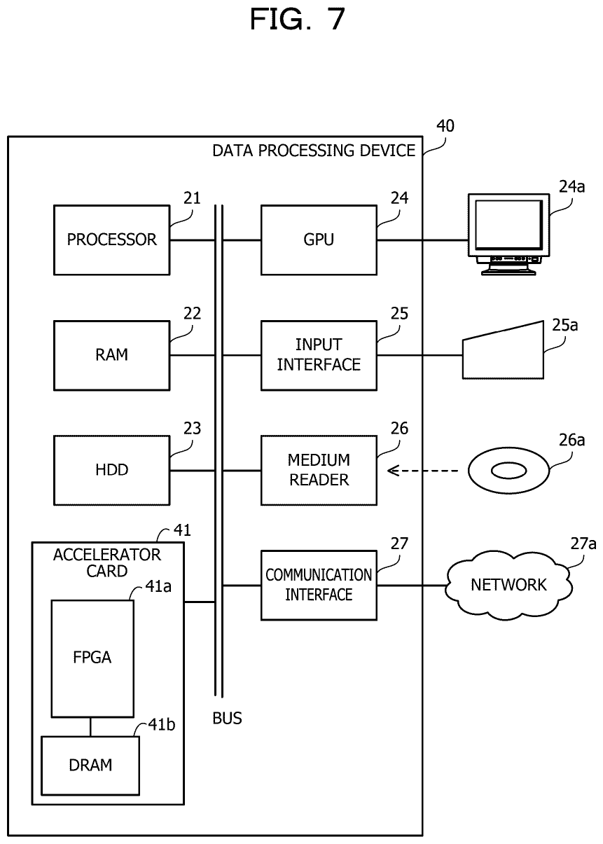

FIG. 7 is a diagram illustrating another example of the data processing device. In FIG. 7, the same elements as those illustrated in FIG. 2 are denoted by the same reference signs.

A data processing device 40 includes an accelerator card 41 coupled to a bus.

The accelerator card 41 is a hardware accelerator that searches for a solution to a combinatorial optimization problem. The accelerator card 41 includes an FPGA 41a and a DRAM 41b.

In the data processing device 40, the FPGA 41a and the DRAM 41b perform, for example, the processing of the processing unit 12 and the storage unit 11 illustrated in FIG. 1 or the processing of the control unit 32 and the search unit 33 illustrated in FIG. 3. In this case, each unit of the processing unit 12 and the storage unit 11 illustrated in FIG. 1 or the control unit 32 and the search unit 33 illustrated in FIG. 3 is implemented by various circuits built in the FPGA 41a, a memory in the FPGA 41a, or the DRAM 41b.

Note that there may be a plurality of the accelerator cards 41.

While one aspect of the data processing devices, the programs, and the data processing methods according to the embodiments has been described above based on the embodiments, this is merely an example and is not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing device comprising:
a memory configured to store evaluation function information of an evaluation function of a combinatorial optimization problem represented by a sum of a quadratic cost term and a linear cost term that is a sum of a plurality of constraint terms weighted by a coefficient that represents a weight of each of a plurality of constraint conditions; and
a processor configured to acquire the evaluation function information from the memory, search for a solution to the combinatorial optimization problem based on the evaluation function information, increase a value of the coefficient that corresponds to a first constraint condition in a case where there is the first constraint condition in which constraint violation occurs among the plurality of constraint conditions at a first time point during the search for the solution, and determine whether to decrease or maintain the value of the coefficient that corresponds to the plurality of constraint conditions based on a result of comparison between a value of the quadratic cost term at the first time point and a value of the evaluation function obtained before the first time point in a case where the plurality of constraint conditions is satisfied at the first time point.

2. The data processing device according to claim 1, wherein
the processor decreases the value of the coefficient that corresponds to the plurality of constraint conditions when the value of the quadratic cost term at the first time point is equal to or greater than a minimum value among the values of the evaluation function obtained before the first time point, and maintains the value of the coefficient that corresponds to the plurality of constraint conditions when the value of the quadratic cost term at the first time point is smaller than the minimum value.

3. The data processing device according to claim 1, wherein the first time point is a time point that arrives each time processing of searching for the solution is performed a predetermined number of times.

4. The data processing device according to claim 1, wherein the processor corrects a value of the linear cost term by using a change amount of the value of the coefficient in a case where the value of the coefficient is changed.

5. The data processing device according to claim 1, wherein the processor determines that the plurality of constraint conditions is satisfied in a case where a value of the linear cost term is 0, and determines that constraint violation occurs in any one of the plurality of constraint conditions in a case where the value of the linear cost term is greater than 0.

6. A non-transitory computer-readable recording medium storing a data processing program for causing a computer to execute a process comprising:
acquiring, from a memory, evaluation function information of an evaluation function of a combinatorial optimization problem represented by a sum of a quadratic cost term and a linear cost term that is a sum of a plurality of constraint terms weighted by a coefficient that represents a weight of each of a plurality of constraint conditions;
searching for a solution to the combinatorial optimization problem based on the evaluation function information;
increasing a value of the coefficient that corresponds to a first constraint condition in a case where there is the first constraint condition in which constraint violation occurs among the plurality of constraint conditions at a first time point during the search for the solution; and
determining whether to decrease or maintain the value of the coefficient that corresponds to the plurality of constraint conditions based on a result of comparison between a value of the quadratic cost term at the first time point and a value of the evaluation function obtained before the first time point in a case where the plurality of constraint conditions is satisfied at the first time point.

7. A data processing method implemented by a computer, the processing method comprising:
acquiring, from a memory, evaluation function information of an evaluation function of a combinatorial optimization problem represented by a sum of a quadratic cost term and a linear cost term that is a sum of a plurality of constraint terms weighted by a coefficient that represents a weight of each of a plurality of constraint conditions;
searching for a solution to the combinatorial optimization problem based on the evaluation function information;
increasing a value of the coefficient that corresponds to a first constraint condition in a case where there is the first constraint condition in which constraint violation occurs among the plurality of constraint conditions at a first time point during the search for the solution; and
determining whether to decrease or maintain the value of the coefficient that corresponds to the plurality of constraint conditions based on a result of comparison between a value of the quadratic cost term at the first time point and a value of the evaluation function obtained before the first time point in a case where the plurality of constraint conditions is satisfied at the first time point.
